(19) United States
(12) Patent Application Publication
(10) Pub. No.: US 2009/0041566 A1
(43) Pub. Date: Feb. 12, 2009

(54) Extractor of dry grains from a silo bag

(76) Inventor: Egar Ramon Lambertini, Cordoba (AR)

Correspondence Address: DEFILLO & ASSOCIATES, INC., P.O. Box 14104, Clearwater, FL, 33766, US

(21) Appl. No.: 11/890,720

(22) Filed: Aug. 7, 2007

(51) Int. Cl. B60P 1/40

(52) U.S. Cl. 414/526

(57) ABSTRACT

The chassis provides a hollow vertical frame connected to a floating extraction unit and two platforms which are formed by several panels transversally aligned to each side of an unloading pipe, which feeds a folding unloading tube. Between the extraction unit and the vertical frame, it is provided a spring unit and a hydraulic cylinder, both modifiers of the height. The extraction unit is formed by a central worm and two lateral worms, hydraulically adjustable in height, and two sweeping units. Each sweeping unit is connected to a plate over which there is supply for deviating the grain. Under it, there are settled the pipes of the hydraulic circuit, a scrapper of the inner wall of the silo-bag connected to the front edge of such plate, shaped as a flexible laminar body. Furthermore, it has an box bearing at least one floating brush, which bristles exceed the lower edge of the plate and they are in permanent contact with the ground of the silo-bag. The lateral worms provide a varying handhole of the opening and closing angles.

### FIELD OF THE INVENTION

This invention consists in an extractor of dry grains from a silo-bag.

### BACKGROUND OF THE INVENTION

In order to save costs it is known that when making the harvest, the grain is stored in special bags left in the ground.

Due to the function that such bags are made for, herein they are called silo-bags.

In this way, the grain is protected inside the silo-bag until the moment for sending it to the place of destination and it is not necessary to carry it to a conventional silo or to make a second transportation to the place of destination.

When the time to move the grain stored comes, the silo-bags are cut and emptied from their content and such is transferred to the truck that will take it to the place of destination.

According to the proceeding described before, the transfer of grains from the place of the harvest to the place of the storage previously to the transfer to the final destination is avoided.

With such system, the need to count with an appropriate place to store the harvest until the moment of its transfer to the final destination is also avoided.

The problem arising related to the usage of the silo-bags is the way to cut and empty the bags to get all the grains contained there.

### SUMMARY OF THE INVENTION

As stated herein, this invention solves a series of problems arising from the usage of this new method of storage of harvest of dry grains, since it is subject matter of this invention to count with a way to make the cutting and emptiness of the silo-bag possible.

It is also subject matter of this invention a unit that allows extracting all the grains contained in such silo-bags and lifting them to the box of the vehicle that may transport them.

It is also subject matter of this invention a unit that allows the height and width of such to vary at any time, even when the equipment is functioning.

### BRIEF DESCRIPTION OF THE DRAWINGS

FIG. 1 outlines a view of the invention from the top where some of its parts may be observed.

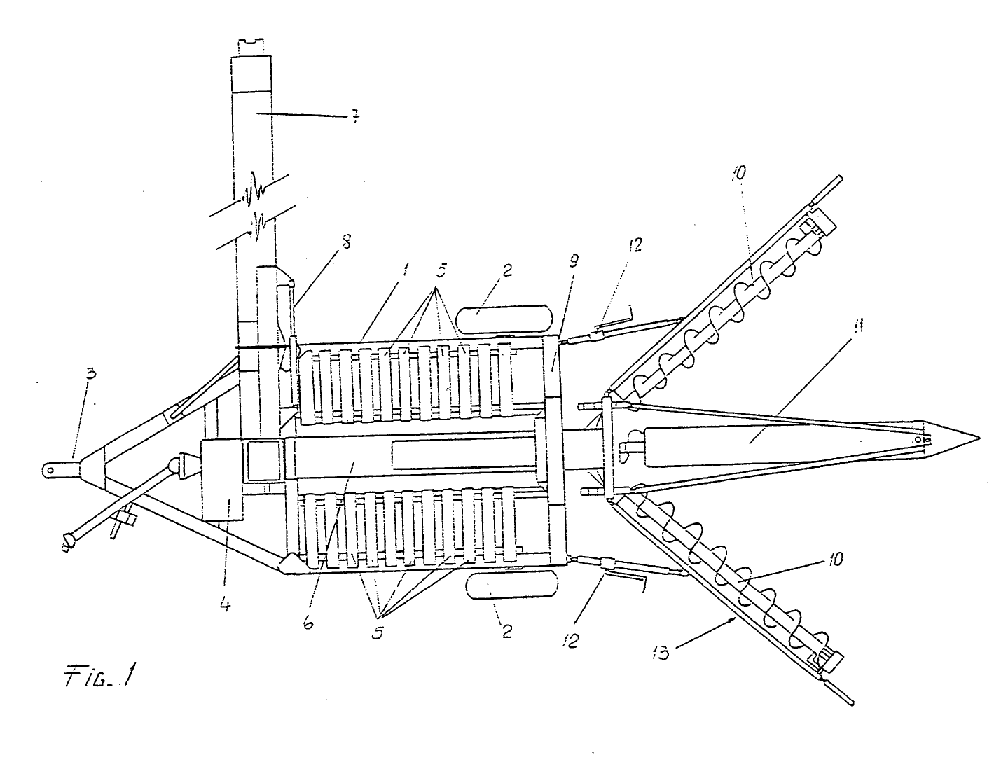

FIG. 2 outlines a perspective view of a sweeping unit, where a section allows appreciating the setting of several pieces as well as the relative position of such pieces.

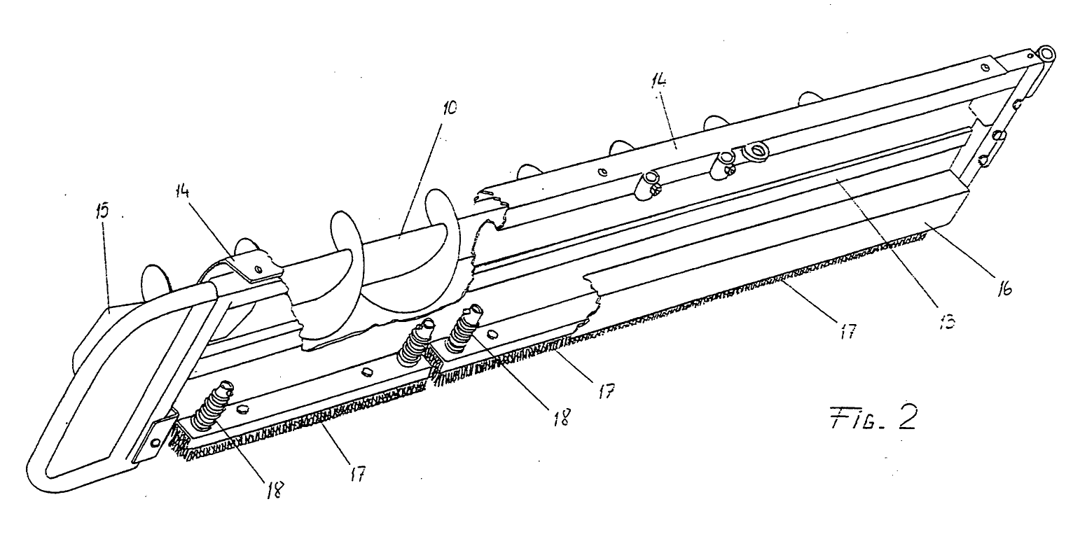

### DETAILED DESCRIPTION OF THE INVENTION

In order to make this invention understandable so as to be carried out easily, an accurate description of a preferable way of carrying it out it is given in the paragraphs hereinafter mentioned, by making reference to the illustrative drawings attached hereto. The description is given purely as a demonstrative example, but not limited, of the invention. Its components may be selected from several similar devices, but it shall be dully follow the principals of the invention set forth in this document.

In the drawings described previously, the references show same parts or similar parts, being number 1, a chassis; number 2, a wheel; number 3, a spear; and number 4, an hydraulic pump.

With number 5 is established a panel; with number 6, an unloading pipe; with number 7, an unloading tube; and with number 8, a hydraulic cylinder.

Number 9 indicates a vertical frame; number 10, a lateral worm; number 11, a central worm; and number 12, a handhole.

Number 13 refers to a plate; number 14, a supply; number 15, a scrapper; and number 16, a box.

Number 17 refers to a brush; number 18, a spring; and number 19, a cardanic rod.

Basically, this invention provides a chassis settled on wheels and a floating unit of extraction together with a unit for cutting, a unit for deviation of the edges of a silo-bag, a central worm, two lateral worms, two sweeping units, an unloading tube, an unloading worm, adjustment units and appropriate means to achieve the movement of the different elements.

FUNCTIONING: Once the different elements of the version developed to explain its nature are established, there follows the description bearing the functional and operative relation of its parts and of the result they provide.

In order to provide an extractor of grains from the silo-bags, it is provided a chassis 1 settled on wheels 2 and supplied with a spear 3 attached to a farm tractor (not represented).

From the power take-off of such farm tractor a hydraulic pump 4 is fed, which provides movement to the different parts described herein after.

On the chassis 1 there are set two platforms suitable for an operator to walk on them safely and so to control the different mechanisms as well as the entire progress in the unloading part.

Both platforms are composed of several panels 5 transversally aligned to each side of the unloading pipe 6, where the extracted grain from the silo-bag passes through towards the unloading tube 7. In its interior, it is provided an unloading worm (not represented).

The unloading tube 7 provides an anchorage for the arm of the hydraulic cylinder 8, which when withdrawing, it allows its folding, and so making the transferring easier, and when extending, it allows to locate it in the right position to unload the extracted grain from the silo-bag.

The control of such hydraulic cylinder 8 is performed by an auxiliary distributor (not represented) while the unloading worm located inside the unloading tube 7 is operated from the power take-off, through a box in the hydraulic pump.

In the front part of the chassis 1 it is provided a hollow vertical frame 9, which operates as a deposit for the hydraulic fluid, that feeds a pump (not represented) of fixed volume and two hydraulic engines (not represented) connected in a row and used for the operation of the two lateral worms 10 as well as to vary its inclination angles.

The extraction unit is composed by both lateral worms 10 and the central worm 11 which, when pouring the extracted grain in the unloading pipe 6 which feeds the unloading worm set inside the unloading tube 7, arise the grain up to the top ending of such unloading tube 7 falling in the box of an appropriate vehicle (not represented).

The silo-bags currently in the market are of three different measures, having the biggest a diameter of 3 meters approximately, a longitude of 60 meters and an estimated capacity of 200 tons approximately.

However, when filling them, the weight of the grains brings about that they cannot keep the cylindrical form, and they make themselves flatter, bearing a width nearly to 4 meters.

Therefore, and even to compensate variations that may be produced inside one same silo-bag, it is necessary a unit that can adequate the width of extraction.

This is achieved by modifying the working angle, i.e., the opening or closing of the lateral worms 10 and to that purpose, work shall be done on the handhole 12 provided for such purpose.

Such handhole 12 may consists in hydraulic cylinders operated from the hydraulic pump or they can consist in a manual mechanism, screw type, providing an ending attached to the lateral worm 10 and the other ending attached to the vertical frame 9 or the chassis 1.

In order to ensure that all the grains inside the silo-bag are extracted, two weeping units are provided, which pushes the grain towards the lateral worms 10.

Each sweeping unit is located at a determined height, which may be independently adjustable from the height of the respective lateral worm 10.

Each of said sweeping unit is connected to a plate 13, leaving the lateral worm 10 in the inner side, i.e., such plate 13 is settled against the inner wall of the silo-bag, protecting it from hooking, that can lead to its breakage, and therefore the waste of its content.

On the top edge of such plate 13, it is connected a supply 14 which consists of a laminar body which allows the grain to slip on it towards the lateral worm 10 and, at the same time, protects the pipes of the hydraulic circuit located beneath it.

In the front edge of the plate 13, it is located a scrapper 15 which consists of a flexible laminar body that when making contact with the inner wall of the silo-bag, it deflects the grain in its way, towards the center.

In the external side of the plate 13, it is provided a box 16, and at least one brush 17 is set on it, which bristles, that exceed the lower edge of such plate 13, are making contact with the floor of the silo-bag, sweeping the grain from the laterals to the center of the bag.

At least one brush 17 is located over springs which provides and independent flotation of the movement of the lateral worm 10. When adjusting the irregularities of the ground where the silo-bag is located, the brush stays always in contact with the ground.

The extraction unit of grains, such as it is described, is of the floating type and it is connected to the vertical frame 9 and through it, to the chassis 1 through a set of springs 18 which provides the flotation needed in order to adjust to the differences in the ground. The height may be adjusted by acting on a hydraulic cylinder (not represented) operated by the auxiliary distributor of the farm tractor.

Such possibility of modifying the height of the extracting unit, plus the possibility to hydraulically regulate the height of the lateral worms 10 as well as the central worm 11 from the farm tractor, and also the height of the work of the brush or brushes 17 allow changing the height of the extraction itself.

When by failures of storage or by nature, part of the grain content in a silo-bag has begun to decay, such modification of height of the extraction is particularly important.

In the front ending of the extraction unit, it is provided a unit for cutting (not represented), such as for example a blade, which is set in an adjustable height in order to adequate it to the size of the silo-bag or to the quantity of grains contained in such.

When putting the chassis 1 in front of the silo-bag to open, it can be adjusted the height of such unit for cutting, that when tearing the material of the bag, an opening shall be made where the lateral worms 10 and the central worm 11 are located.

The edges of the silo-bag shall therefore be parted off by the corresponding units of deviation located at both sides of the unit for cutting.

Such units of deviation make easier the tearing of the essential material of the silo-bag and they separate it from the way of the extraction unit, avoiding it to fall in the lateral worms 10 or in the central worm 11.

The mentioned deviation of the material is completed with the action of the sweeping units already described.

The hydraulic pump 3 provides a cardanic rod 19 for its connection to the power take-off of the farm tractor.

Therefore, it has been shown one of the possibilities that take to make this invention possible and the way that the same works. The documentation provided hereinafter contains the synthesis of the invention in the following terms.

After having described and determined the nature of the invention, its scope and the way the same may be basically put into practice, it is declared as invention and of exclusive property the following:

What is claimed is:

1. An extractor of dry grain from a silo-bag comprising:
a chassis having wheels,
a spear mounted on the chassis, wherein the spear is adapted to be linked to a tractor;
an hydraulic pump for providing power to the elements on the chasis,
cutting means for the cutting the silo-bag,
at least one worm in contact with the grain stored inside the silo-bag, and
an unloading worm inside an unloading tube;
wherein the chassis includes a hollow vertical frame linked to a set of floating extraction and two platforms having several panels transversally aligned to each side of an unloading pipe, which feeds a folding unloading tube;
wherein between such extraction unit and the vertical frame it is provided a set of springs and an hydraulic cylinder that modifies the height of the extraction unit;
wherein the extraction unit has a central worm and two lateral worms, hydraulically adjustable in height and both sweeping units, each of them fixed to a plate on which a deviating device of the grain is settled, and under it, the pipes of the hydraulic circuits are settled;
wherein it is settled a scrapper of the inner wall of the silo-bag related to the front edge of such plate, shaped as a flexible laminar body, and an box of at least one floating brush, which bristles, exceeding the inner edge of such plate, are in permanent contact with the floor of the silo-bag and which lateral worms provide a variable handhole of the opening and closing angles.

2. The extractor according to claim 1, the brushes are set on springs which compensate the irregularities of the ground on which the silo-bag is located.

3. The extractor according to claim 1, wherein the height of each sweeping unit is adjustable regardless the height of the respective lateral worm.

4. The extractor according to claim 1, wherein the handholes of the lateral worms are hydraulic cylinders controlled from the hydraulic pump and they provide an ending connected to the lateral worm and the other ending to the vertical frame or to the chassis.

5. The extractor according to claim 1, wherein the unloading tube provides an anchor for the arm of an hydraulic cylinder controlled by an auxiliary operator, provides a folding movement for its transportation and an extension movement for the unloading of the grain extracted from the silo-bag.

6. The extractor according to claim 1, wherein the unloading worm located inside the unloading tube is controlled from the power take-off through a box in the hydraulic pump.

7. The extractor according to claim 1, further comprising several units of deflection of the material from the silo-bag located at both sides of a unit for cutting, that has an adjustable height.

8. The extractor according to claim 1, wherein the hydraulic fluid of the hydraulic circuit is set in the hollow vertical frame.

9. The extractor according to claim 1, wherein the hydraulic pump having a cardanic rod connected to the power take-off of the farm tractor.

10. The extractor according to claim 1, further comprising two hydraulic engines connected in a row feed the hydraulic circuit for making the lateral worms and the variation of its inclination angles work.
